(19) United States
(12) Patent Application Publication
(10) Pub. No.: US 2009/0096762 A1
(43) Pub. Date: Apr. 16, 2009

(54) INPUT DEVICE, DISPLAY DEVICE WITH INPUT FUNCTION, AND ELECTRONIC APPARATUS

(75) Inventor: Shoji Hinata, Matsumoto (JP)

Correspondence Address: HARNESS, DICKEY & PIERCE, P.L.C., P.O. BOX 828, BLOOMFIELD HILLS, MI, 48303, US

(73) Assignee: Epson Imaging Devices Corporation, Azumino-shi (JP)

(21) Appl. No.: 12/193,795

(22) Filed: Aug. 19, 2008

(30) Foreign Application Priority Data
Oct. 16, 2007 (JP) 2007-268676
Jun. 2, 2008 (JP) 2008-144365

(51) Int. Cl. G06F 3/044

(52) U.S. Cl. 345/174

(57) ABSTRACT

An input device includes: a resistive film type input unit; and a non-contact type input unit that overlaps at least a portion of the resistive film type input unit. The resistive film type input unit includes: first and second substrates each having a first surface and a second surface; a first electrode that is formed on the first surface of the first substrate; and a second electrode that is formed on the first surface of the second substrate. The second substrate is provided on an input operation side of the first substrate, and the first electrode of the first substrate faces the second electrode of the second substrate. The resistive film type input unit is in a standby state that does not perform input detection until an input to the non-contact type input unit is detected. When the input to the non-contact type input unit is detected, the resistive film type input unit is turned on to perform input detection.

The entire disclosure of Japanese Patent Application Nos. 2007-268676, filed Oct. 16, 2007 and 2008-144365, filed Jun. 02, 2008 are expressly incorporated by reference herein.

### BACKGROUND

1. Technical Field

The present invention relates to an input device including a resistive film type panel capable of detecting a position where, for example, a finger is contacted, a display device with an input function including the input device, and an electronic apparatus.

2. Related Art

In recent years, electronic apparatuses in which an input device, which is called a touch panel, is provided on a liquid crystal display device, such as mobile phones, car navigation systems, personal computers, ticket machines, and banking terminals, have been developed. This type of electronic apparatus allows a user to input information while viewing an image displayed in an image display area of the liquid crystal display device.

Among these touch panels, a resistive film type touch panel includes a first substrate and a second substrate opposite to each other, and a first electrode and a second electrode are formed on surfaces of the first substrate and the second substrate facing each other. When the second substrate is pressed, a contact position between the first electrode and the second electrode is detected, thereby detecting input coordinates. In addition, there is a capacitance type touch panel which includes one substrate having an electrode formed thereon. In the capacitance type touch panel, when, for example, a finger contacts and approaches the touch panel, a variation in capacitance between the electrode and the finger is detected, thereby detecting input coordinates. Since the capacitance type touch panel is a non-contact type, it has high durability, unlike the resistive film type touch panel. However, the capacitance type touch panel has disadvantages in that it is difficult to input information with fingers or a pen.

In order to solve the above problems, a structure has been proposed in which a resistive film type input device and a capacitance type input device are separately manufactured, and overlap each other without any gap therebetween to detect plural kinds of pressed states (Japanese Unexamined Patent Application Publication No. 7-334308).

However, in the structure in which a touch panel overlaps an image generating device to form a display device with an input function, even though only the function of the display device is used, power is supplied to an IC for driving the touch panel to detect signals, which results in high power consumption.

### SUMMARY

An advantage of some aspects of the invention is that provides an input device capable of reducing power consumption, a display device with an input function including the input device, and an electronic apparatus.

According to an aspect of the invention, an input device includes: a resistive film type input unit; and a non-contact type input unit that overlaps at least a portion of the resistive film type input unit. The resistive film type input unit includes: first and second substrates each having a first surface and a second surface; a first electrode that is formed on the first surface of the first substrate; and a second electrode that is formed on the first surface of the second substrate. The second substrate is provided on an input operation side of the first substrate, and the first electrode of the first substrate faces the second electrode of the second substrate. The resistive film type input unit is in a standby state that does not perform input detection until an input to the non-contact type input unit is detected. When the input to the non-contact type input unit is detected, the resistive film type input unit is turned on to perform input detection.

According to the above-mentioned structure, the non-contact type input unit is provided on the input operation side of the resistive film type input unit, and the resistive film type input unit is in the standby state that does not perform input detection until a conductor contacts or approaches the non-contact type input unit (that is, an input to the non-contact type input unit is detected). When a conductor contacts or approaches the non-contact type input unit (that is, an input to the non-contact type input unit is detected), the resistive film type input unit is turned on to perform input detection. Therefore, it is possible to reduce power consumption. In particular, in the related art, a current is applied to the first electrode and the second electrode of the resistive film type input unit almost all the time, which results in high power consumption. However, according to the above-mentioned aspect, since the resistive film type input unit is in the standby state, it is possible to certainly reduce power consumption. Further, even when a user's finger approaches the non-contact type input unit to input information, without contacting it, it is possible to detect the input of information. Therefore, it is possible to smoothly change the resistive film type input unit from the standby state to an on state.

According to another aspect of the invention, an input device includes: a resistive film type input unit; and a capacitance type input unit. The resistive film type input unit includes: first and second substrates each having a first surface and a second surface; a first electrode that is formed on the first surface of the first substrate; and a second electrode that is formed on the first surface of the second substrate. The second substrate is provided on an input operation side of the first substrate, and the first electrode of the first substrate faces the second electrode of the second substrate. The capacitance type input unit includes third electrodes that are provided on the second surface of the second substrate. The resistive film type input unit is in a standby state that does not perform input detection until an input to the capacitance type input unit is detected. When the input to the capacitance type input unit is detected, the resistive film type input unit is turned on to perform input detection.

According to the above-mentioned structure, the capacitance type input unit is provided on the input operation side of the resistive film type input unit, and the resistive film type input unit is in the standby state that does not perform input detection until a conductor contacts or approaches the capacitance type input unit (that is, an input to the capacitance type input unit is detected). When a conductor contacts or approaches the capacitance type input unit (that is, an input to the capacitance type input unit is detected), the resistive film type input unit is turned on to perform input detection. Therefore, it is possible to reduce power consumption. In particular, in the related art, a current is applied to the first electrode and the second electrode of the resistive film type input unit almost all the time, which results in high power consumption. However, according to the above-mentioned aspect, since the resistive film type input unit is in the standby state, it is possible to certainly reduce power consumption. Further, even when a user's finger approaches the capacitance type input unit to input information, without contacting it, it is possible to detect the input of information. Therefore, it is possible to smoothly change the resistive film type input unit from the standby state to an on state.

In the input device according to the above-mentioned aspect, preferably, the first electrode and the second electrode are maintained at the ground potential in the standby state. According to this structure, the first electrode and the second electrode serve as a shield layer for the capacitance type input unit. Therefore, when the resistive film type input unit is in the standby state, it is possible to prevent the erroneous operation of the capacitance type input unit due to external noise.

In the input device according to the above-mentioned aspect, preferably, the third electrodes are formed on the second surface of the second substrate. According to this structure, it is possible to form an input device with a small number of parts.

In the input device according to the above-mentioned aspect, preferably, the third electrodes are formed on a thin base that is composed of a sheet or a substrate different from the second substrate. In this case, preferably, the base is provided such that the third electrodes face the second surface of the second substrate. According to this structure, the base faces the input operation side and serves as a protective layer for the third electrodes.

In the input device according to the above-mentioned aspect, preferably, an input region of the capacitance type input unit and an input region of the resistive film type input unit have different areas in plan view. According to this embodiment, even when a user's finger approaches the capacitance type input unit to input information, without contacting it, it is possible to detect the input of information. Therefore, it is possible to smoothly change the resistive film type input unit from the standby state to an on state.

According to still another aspect of the invention, a display device with an input function includes: the input device according to the above-mentioned aspect; and an image generating device that is provided on one surface of the first substrate of the input device that is opposite to the second substrate.

In the display device with an input function according to the above-mentioned aspect, preferably, the image generating device includes a pair of substrates and an electro-optical material that is interposed between the pair of substrates, and the first substrate also serves as one of the pair of substrates. According to this structure, it is possible to reduce the number of substrates of the image generating device or the input device. As a result, it is possible to reduce the thickness of a display device with an input function.

The display device with an input function according to the above-mentioned aspect may be applied to various electronic apparatuses, such as mobile phones, car navigation systems, personal computers, ticket machines, and banking terminals.

### BRIEF DESCRIPTION OF THE DRAWINGS

The invention will be described with reference to the accompanying drawings, wherein like numbers reference like elements.

FIG. 1A is a diagram schematically illustrating the structure of a display device with an input function according to the invention.

FIG. 1B is a block diagram illustrating the electrical structure of the display device with an input function.

FIG. 2 is a cross-sectional view schematically illustrating the structure of a display device with an input function according to a first embodiment of the invention.

FIG. 3 is a cross-sectional view schematically illustrating the structure of a display device with an input function according to a second embodiment of the invention.

FIG. 4 is a cross-sectional view schematically illustrating the structure of a display device with an input function according to a third embodiment of the invention.

FIG. 5 is a cross-sectional view schematically illustrating the structure of a display device with an input function according to a fourth embodiment of the invention.

FIGS. 6A to 6C are diagrams illustrating electronic apparatuses provided with the display device with an input function according to the embodiments of the invention.

FIG. 7 is a cross-sectional view schematically illustrating the structure of a display device with an input function according to a fifth embodiment of the invention.

FIG. 8 is a cross-sectional view schematically illustrating the structure of a display device with an input function according to a sixth embodiment of the invention.

### DESCRIPTION OF EXEMPLARY EMBODIMENTS

Hereinafter, exemplary embodiments of the invention will be described with reference to the accompanying drawings. In the following drawings, a scale of each layer or member is adjusted in order to have a recognizable size.

### First Embodiment

Overall structure

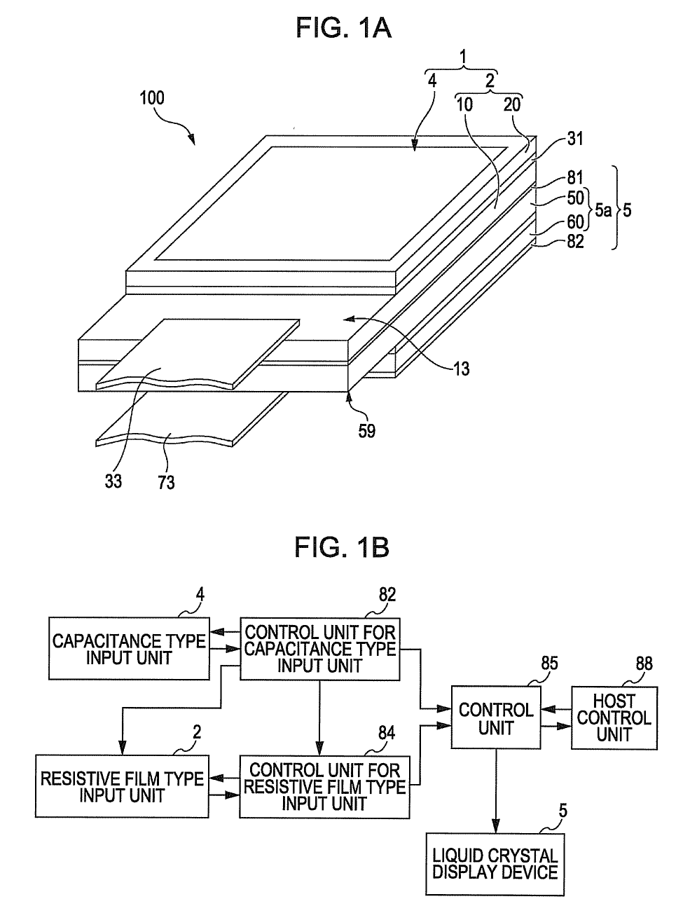

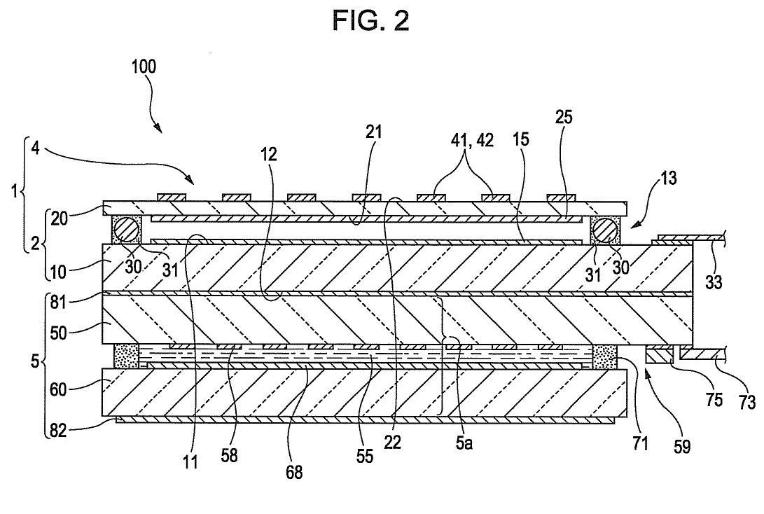

FIG. 1A is a diagram schematically illustrating the structure of a display device with an input function according to a first embodiment of the invention, and FIG. 1B is a block diagram illustrating the electrical structure of the display device with an input function. FIG. 2 is a cross-sectional view schematically illustrating the structure of the display device with an input function according to the first embodiment of the invention. In FIG. 2, the number of electrodes of an input device and the number of pixel electrodes or opposite electrodes of a liquid crystal display device are smaller than the actual numbers, for clarity of description.

In FIGS. 1A and 2, a display device 100 with an input function according to the first embodiment mainly includes a liquid crystal display device 5, serving as an image generating device, and an input device 1 that is provided on one surface of the liquid crystal display device 5 from which display light is emitted.

The liquid crystal display device 5 includes a transmissive, reflective, or transflective active matrix liquid crystal panel 5a. In this embodiment, since the liquid crystal panel 5a is a transmissive type, a backlight unit (not shown) is provided on one surface of the liquid crystal panel that is opposite to the other surface from which display light is emitted. In addition, in the liquid crystal display device 5, 1a first polarizing plate 81 is provided on the other surface of the liquid crystal panel 5a from which display light is emitted, and a second polarizing plate 82 is provided on the one surface of the liquid crystal panel opposite to the light emission side.

The liquid crystal panel 5a includes a transmissive element substrate 50 that is provided on the emission side of display light and a transmissive opposite substrate 60 that is arranged opposite to the element substrate 50. The opposite substrate 60 and the element substrate 50 are bonded to each other by a frame-shaped sealing material 71, and a liquid crystal layer 55 (electro-optical material layer) is provided in an area surrounded by the sealing material 71 between the opposite substrate 60 and the element substrate 50.

A plurality of pixel electrodes 58 are formed on one surface of the element substrate 50 that faces the opposite substrate 60, and a common electrode 68 is formed on one surface of the opposite substrate 60 that faces the element substrate 50. The common electrode 68 may be formed on the element substrate 50. In addition, the opposite substrate 60 may be provided on the emission side of display light.

In the element substrate 50, a driving IC 75 is mounted on a protruding region 59 that protrudes from the edge of the opposite substrate 60 by a COG technique, and a flexible substrate 73 is connected to the protruding region 59. A driving circuit may be formed simultaneously with switching elements on the element substrate 50.

### Detailed Structure of Input Device 1

The input device 1 according to this embodiment includes a resistive film type input unit 2 that overlaps the liquid crystal display device 5 and a capacitance type input unit 4 that is arranged on the input operation side of the resistive film type input unit 2. The capacitance type input unit 4 overlaps the resistive film type input unit 2 in plan view.

In this embodiment, the resistive film type input unit 2 includes a first transmissive substrate 10 that is formed of, for example, a glass plate or a plastic plate, and a second transmissive substrate 20 that is formed of, for example, a glass plate or a plastic plate. In this embodiment, both the first substrate 10 and the second substrate 20 are formed of glass plates. The first substrate 10 and the second substrate 20 are bonded to each other by a frame-shaped sealing material 31 such that their first surfaces 11 and 21 are opposite to each other with a predetermined gap therebetween. The second substrate 20 is arranged on the input operation side, and the first substrate 10 is arranged on the liquid crystal display device 5. Therefore, a second surface 22 of the second substrate 20 faces the input operation side, and a second surface 12 of the first substrate 10 faces the liquid crystal display device 5. In the resistive film type input unit 2 having the above-mentioned structure, when an input operation is performed, it is necessary to bend the second substrate 20. Therefore, the second substrate 20 has a thickness smaller than the first substrate 10 and has flexibility.

On the first surface 11 of the first substrate 10, a flexible substrate 33 is connected to a protruding region 13 that protrudes from the edge of the second substrate 20. The flexible substrate 33 is a wiring member that outputs signals from the resistive film type input unit 2 to the outside.

In the resistive film type input unit 2 of the input device 1, a first transmissive electrode 15 that is composed of an ITO (indium tin oxide) film is formed on the first surface 11 of the first substrate 10, and a second transmissive electrode 25 that is composed of an ITO film is formed on the first surface 21 of the second substrate 20. In addition, an air layer is provided therebetween. A wiring pattern (not shown) is formed on the first surface 11 of the first substrate 10 so as to extend from the first electrode 15 to the protruding region 13, and the wiring pattern makes it possible to output signals from the first electrode 15 to the flexible substrate 33. In addition, an inter-substrate conductive material 30, such as plastic beads having surfaces coated with a metal layer, is mixed with the sealing material 31. The inter-substrate conductive material 30 is interposed between the first surface 11 of the first substrate 10 and the first surface 21 of the second substrate 20, and electrically connects the second electrode 25 formed on the first surface 21 of the second substrate 20 and the wiring pattern (not shown) formed on the first surface 11 of the first substrate 10. The inter-substrate conductive material 30 and the wiring pattern make it possible to output signals from the second electrode 25 to the flexible substrate 33.

In the resistive film type input unit 2 having the above-mentioned structure, when the second substrate 20 is pressed, the first electrode 15 contacts the second electrode 25 in the pressed portion. Therefore, it is possible to detect input coordinates by detecting the contact position. Thus, a user can press a predetermined area of the second substrate 20 of the resistive film type input unit 2 with, for example, fingers or a pen to input information.

In the input device 1, third electrodes 41 and 42 forming the capacitance type input unit 4 are formed on the second surface 22 of the second substrate 20 used in the resistive film type input unit 2. The third electrodes 41 and 42 are composed of a transmissive conductive film, such as an ITO film. The third electrodes 41 and 42 are composed of, for example, a plurality of rows of electrode patterns that extend so as to intersect each other. FIG. 2 schematically illustrates the third electrodes 41 and 42 without discriminating them. For example, the third electrodes 41 and 42 may have a structure that includes a large-area portion, such as a pad, or a structure in which triangular patterns that are opposite to each other in the horizontal direction are alternately arranged. The third electrodes 41 and 42 extend to the second surface 22 of the second substrate 20, and a wiring pattern (not shown), such as a flexible substrate, is connected to the ends of the third electrodes 41 and 42.

In the capacitance type input unit 4 having the above-mentioned structure, when a voltage is sequentially applied to a plurality of third electrodes 41 and 42 and a finger, which is a conductor, contacts or approaches any portion of the capacitance type input unit, capacitance is formed between the third electrodes 41 and 42 and the finger, and the capacitance detected by the third electrodes 41 and 42 is lowered. Therefore, it is possible to detect where the finger is contacted or approached. The capacitance type input unit 4 makes it possible for the user to input information with a finger by a non-contact method. However, it is difficult to input information with a pen formed of an insulating material in the capacitance type input unit 4.

The entire input device 1 having the above-mentioned structure passes through light, which makes it possible for the user to input information while viewing the image displayed by the liquid crystal display device 5.

### Operation

As shown in FIG. 1B, the display device 100 with an input function according to this embodiment includes a control unit 84 for a resistive film type input unit that controls the driving of the resistive film type input unit 2 and detects signals therefrom, a control unit 82 for a capacitance type input unit that controls the driving of the capacitance type input unit 4 and detects signals therefrom, and a control unit 85 that controls the overall operation of the display device with an input function. The control unit 85 performs a general control operation on the liquid crystal display device 5, and controls the switching of images displayed by the liquid crystal display device 5 on the basis of the detection results by the control unit 84 for a resistive film type input unit and the control unit 82 for a capacitance type input unit. In addition, the control unit 85 outputs the detection results by the control unit 84 for a resistive film type input unit and the control unit 82 for a capacitance type input unit to a host control unit 88. The operations of the control units are executed on the basis of operating programs that are stored in a storage unit, such as a RAM or a ROM.

In this embodiment, the control unit 84 for a resistive film type input unit is in a standby state that does not perform input detection until a conductor contacts or approaches the capacitance type input unit 4. The standby state means a state in which no current flows to the resistive film type input unit 2, or a state in which current flows to the resistive film type input unit 2, but a position detecting process is not performed. In this embodiment, in the standby state, no current flows to the resistive film type input unit 2, and the first electrode 15 and the second electrode 25 are maintained at the ground potential.

Meanwhile, the control unit 82 for a capacitance type input unit monitors whether a finger contacts or approaches the capacitance type input unit 4 almost all the time. When a finger contacts or approaches the capacitance type input unit 4, the control unit 82 for a capacitance type input unit outputs information indicating the contact or the approach of the conductor to the control unit 84 for a resistive film type input unit. In addition, the control unit 82 for a capacitance type input unit detects where the finger is contacted or approached and outputs the detection result to the control unit 85.

The control unit 84 for a resistive film type input unit is turned on to perform input detection, when the control unit 82 for a capacitance type input unit outputs information indicating that a finger contacts or approaches the capacitance type input unit 4 (that is, an input to the capacitance type input unit is detected). That is, the control unit 84 for a resistive film type input unit starts to supply power when no current has been applied to the resistive film type input unit 2, and performs scanning to detect the contact position of the finger with the resistive film type input unit 2.

In the capacitance type input unit 4, the user moves a cursor key displayed on the liquid crystal display device 5 to scroll the screen displayed on the liquid crystal display device 5. In the resistive film type input unit 2, the user selects one of the selection buttons displayed on the liquid crystal display device 5 with a pen to input information. Alternatively, the user may operate the resistive film type input unit 2 to move the cursor, and use the capacitance type input unit 4 to input information.

### Main Effects of First Embodiment

As described above, in this embodiment, the capacitance type input unit 4 is formed on the input operation side of the resistive film type input unit 2, and the resistive film type input unit 2 is in the standby state that does not perform input detection until a conductor contacts or approaches the capacitance type input unit 4 and the capacitance type input unit 4 detects an input. When a conductor contacts or approaches the capacitance type input unit 4 and the capacitance type input unit 4 detects an input, the resistive film type input unit 2 is turned on to perform input detection. Therefore, it is possible to reduce power consumption. In particular, in the related art, a current is applied to the first electrode 15 and the second electrode 25 of the resistive film type input unit 2 almost all the time, which results in high power consumption. However, according to this embodiment, since the resistive film type input unit 2 is in the standby state, it is possible to certainly reduce power consumption. Further, the capacitance type input unit 4 is arranged on the input operation side of the resistive film type input unit 2. Therefore, even when a user's finger approaches the capacitance type input unit 4 to input information, without contacting it, it is possible to detect the input of information. Therefore, it is possible to smoothly change the resistive film type input unit 2 from the standby state to an on state.

Further, in this embodiment, the first electrode 15 and the second electrode 25 are maintained at the ground potential in the standby state. Therefore, the first electrode 15 and the second electrode 25 serve as a shield layer for the capacitance type input unit 4. As a result, when the resistive film type input unit 2 is in the standby state, it is possible to prevent the erroneous operation of the capacitance type input unit 4 due to external noise.

Furthermore, the third electrodes 41 and 42 are formed on the second surface 22 of the second substrate 20. Therefore, it is possible to form the input device 1 with a small number of parts.

### Second Embodiment

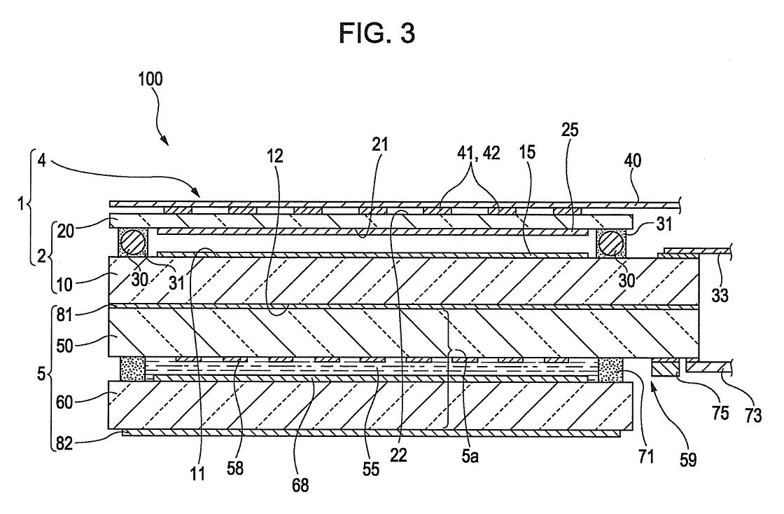

In the first embodiment, the third electrodes 41 and 42 are formed on the second surface 22 of the second substrate 20. However, in a second embodiment, as will be described below with reference to FIG. 3, the third electrodes 41 and 42 are formed on a thin base composed of a sheet or a substrate that is different from the second substrate 20.

FIG. 3 is a cross-sectional view schematically illustrating the structure of a display device 100 with an input function according to the second embodiment of the invention. In this embodiment, the basic structure of the display device with an input function is the same as that in the first embodiment. Therefore, the same components as those in the first embodiment are denoted by the same reference numerals, and thus a description thereof will be omitted.

As shown in FIG. 3, similar to the first embodiment, the display device 100 with an input function according to the second embodiment mainly includes a liquid crystal display device 5, serving as an image generating device, and an input device 1 that is provided on one surface of the liquid crystal display device 5 from which display light is emitted. In addition, the input device 1 includes a resistive film type input unit 2 that overlaps the liquid crystal display device 5, and a capacitance type input unit 4 that is arranged on the input operation side of the resistive film type input unit 2. The capacitance type input unit 4 overlaps the resistive film type input unit 2 in plan view.

In the resistive film type input unit 2 of the input device 1, a first transmissive electrode 15 is formed on a first surface 11 of a first substrate 10, and a second transmissive electrode 25 is formed on a first surface 21 of a second substrate 20.

In this embodiment, a transmissive thin base 40 on which third transmissive electrodes 41 and 42 for forming the capacitance type input unit 4 are formed is provided on the second surface 22 of the second substrate 20 used in the resistive film type input unit 2. In this embodiment, the third electrodes 41 and 42 are formed on the base 40 so as to face the second surface 22 of the second substrate 20. Therefore, the base 40 serves as a protective layer for the third electrodes 41 and 42 on the input operation side. As a result, it is not necessary to form a separate protective layer for the third electrodes 41 and 42. The other structures are the same as those in the first embodiment, and thus a description thereof will be omitted.

Further, when the base 40 is configured to have the function of a first polarizing plate 81, that is, when the base 40 also serves as the first polarizing plate 81, it is possible to omit the first polarizing plate 81. As a result, it is possible to reduce the thickness of the input device 1. However, the invention is not limited to the structure in which the base 40 also serves as the first polarizing plate 81. For example, any of the members provided on the surface of the liquid crystal panel 5a from which display light is emitted may have the function of the first polarizing plate 81.

In the input device 1 and the display device 100 with an input function having the above-mentioned structure, the resistive film type input unit 2 is in the standby state that does not perform input detection until a conductor contacts or approaches the capacitance type input unit 4. When a conductor contacts or approaches the capacitance type input unit 4, the resistive film type input unit 2 is turned on to perform input detection. Therefore, it is possible to reduce power consumption, which is the same effect as that in the first embodiment.

### Third Embodiment

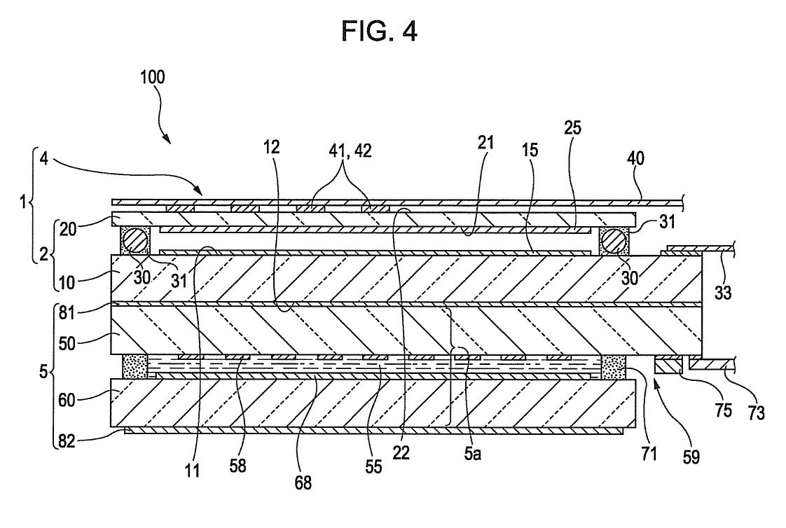

In the first and second embodiments, the capacitance type input unit 4 is formed so as to overlap the entire input region of the resistive film type input unit 2. However, in this embodiment, as will be described below with reference to FIG. 4, the input region of a resistive film type input unit 2 and the input region of a capacitance type input unit 4 may have different areas in plan view.

FIG. 4 is a cross-sectional view schematically illustrating the structure of a display device 100 with an input function according to the third embodiment of the invention. In this embodiment, the basic structure of the display device with an input function is the same as that in the first embodiment. Therefore, the same components as those in the first embodiment are denoted by the same reference numerals, and thus a description thereof will be omitted.

As shown in FIG. 4, similar to the first embodiment, the display device 100 with an input function according to the third embodiment mainly includes a liquid crystal display device 5, serving as an image generating device, and an input device 1 that is provided on one surface of the liquid crystal display device 5 from which display light is emitted. In addition, the input device 1 includes a resistive film type input unit 2 that overlaps the liquid crystal display device 5, and a capacitance type input unit 4 that is arranged on the input operation side of the resistive film type input unit 2. The capacitance type input unit 4 overlaps the resistive film type input unit 2 in plan view. In this embodiment, the area of the input region of the capacitance type input unit 4 (the region in which the third electrodes 41 and 42 are formed) is half or less the area of the input region of the resistive film type input unit 2 (the region in which a first electrode 15 and a second electrode 25 are formed). The other structures are the same as those in the first and second embodiments, and thus a description thereof will be omitted.

### Fourth Embodiment

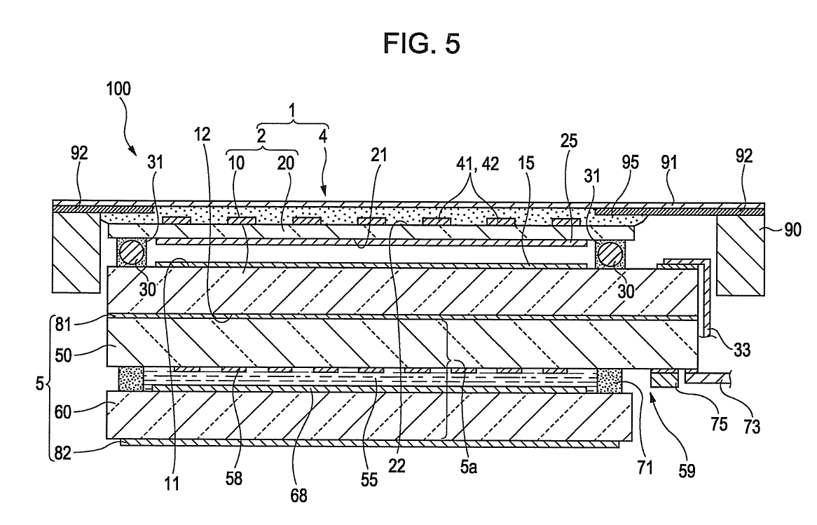

FIG. 5 is a cross-sectional view schematically illustrating the structure of a display device with an input function according to a fourth embodiment of the invention. In the first to third embodiments, the input operation side of the input device 1 is opened. However, in this embodiment, as shown in FIG. 5, a the sheet 91 may be adhered to the input operation side of a frame 90 surrounding the input device 1, and the sheet 91 may be adhered to the input device 1 by an adhesive 95. According to this structure, it is possible to obtain a display device with an input function having various shapes according to the shape of the frame 90, regardless of the shape of the input device 1 in plan view. For example, it is possible to obtain a display device with an input function having R-shaped corners. In addition, the sheet 91 can serve as a protective layer that protects the third electrodes 41 and 42 even when the third electrodes 41 and 42 are directly formed on the second surface 22 of the second substrate 20, as in the first embodiment.

Further, when a light shielding layer 92 is formed on the inner surface of the sheet 91 (the surface facing the resistive film type input unit 2), it is possible to form a frame common to the capacitance type input unit 4, the resistive film type input unit 2, and the liquid crystal display device 5.

Furthermore, although not shown in FIG. 5, a first polarizing plate 81 may be fixed to the sheet 91 on the input operation side of the input device 1 by an adhesive. In this case, the first polarizing plate 81 provided between the input device 1 and the liquid crystal display device 5 is omitted. When the sheet 91 is configured so as to have the function of the polarizing plate 81, that is, when the sheet 91 also serves as the first polarizing plate 81, the first polarizing plate 81 can be omitted, and thus it is possible to reduce the thickness of the input device 1.

### Fifth Embodiment

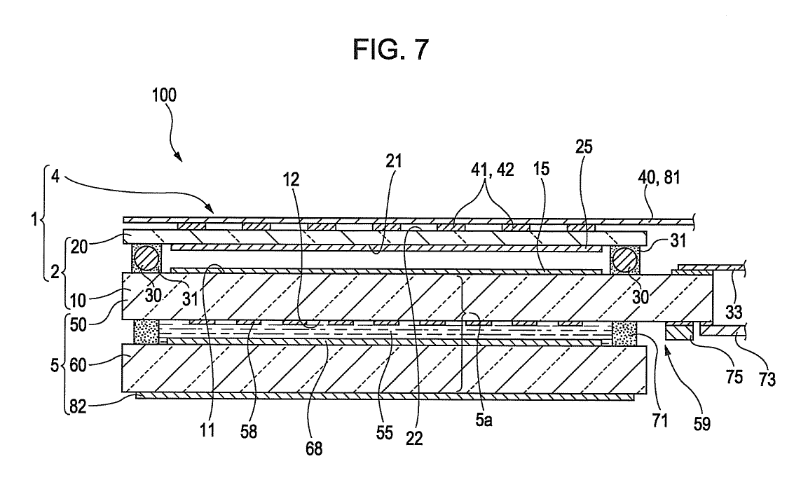

FIG. 7 is a cross-sectional view schematically illustrating the structure of a display device with an input function according to a fifth embodiment of the invention. In the first to fourth embodiments, the first substrate 10 of the input device 1 and the element substrate 50 of the liquid crystal panel 5 are separately provided. However, as shown in FIG. 7, the first substrate 10 of the input device 1 may also serve as the element substrate 50 of the liquid crystal panel 5. According to this structure, it is possible to reduce the overall thickness of a display device 100 with an input function having a laminate of the resistive film type input unit 2 and the capacitance type input unit 4. In this structure, although not shown in FIG. 7, the first polarizing plate that has been arranged between the first substrate 10 and the element substrate 50 of the liquid crystal panel 5 is provided on the front surface or the rear surface of a base 40.

When the base 40 is configured to have the function of the first polarizing plate 81, that is, when the base 40 also serves as the first polarizing plate 81, it is possible to omit the first polarizing plate 81, and thus further reduce the thickness of the display device 100 with an input function. The other structures are substantially the same as those in the second embodiment, and thus a description thereof will be omitted.

### Sixth Embodiment

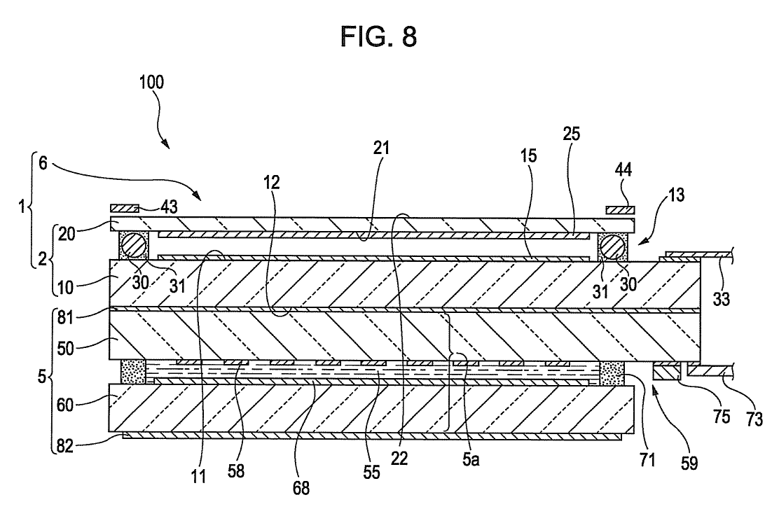

FIG. 8 is a cross-sectional view schematically illustrating the structure of a display device with an input function according to a sixth embodiment of the invention. In the first to fourth embodiments, the input device includes the resistive film type input unit 2 that is provided on the liquid crystal display device 5 and the capacitance type input unit 4 that is provided on the input operation side of the resistive film type input unit 2. However, as shown in FIG. 8, an input device includes an optical input unit 6 instead of the capacitance type input unit 4. In the optical input unit 6 according to this embodiment, for example, infrared light emitting elements and receiving elements are arranged in a matrix on the input operation side surface of the resistive film type input unit 2. When infrared light emitted from the light-emitting element to the receiving element is shielded by a shielding material, the optical input unit detects the coordinates where the infrared light is shielded. The optical input unit can detect coordinates in a non-contact manner. However, the detection method of the optical input unit is not limited thereto. Any detection method may be used as long as the optical input unit can detect coordinates in a non-contact manner. In addition, the invention is not limited to the optical input unit, but any input unit may be used as long as it can detect the contact or approach of a conductor to the input operation side rather than to the resistive film type input unit 2. The other structures are substantially the same as those in the first embodiment, and thus a description thereof will be omitted.

In this embodiment, the input device includes the resistive film type input unit 2 and the optical input unit 6, and the resistive film type input unit 2 is in a standby state that does not perform input detection until a conductor contacts or approaches the optical input unit 6 (that is, an input to a non-contact type input unit is detected). When a conductor contacts or approaches the optical input unit 6 (that is, an input to a non-contact type input unit is detected), the resistive film type input unit 2 is turned on to perform input detection. Therefore, it is possible to reduce power consumption. In particular, in the related art, a current is applied to the first electrode 15 and the second electrode 25 of the resistive film type input unit 2 almost all the time, which results in high power consumption. However, according to this embodiment, since the resistive film type input unit 2 is in the standby state, it is possible to certainly reduce power consumption. Further, even when a user's finger approaches the optical input unit 6 to input information, without contacting it, it is possible to detect the input of information. Therefore, it is possible to smoothly change the resistive film type input unit 2 from the standby state to an on state.

### Other Structures

In the first to sixth embodiments, the liquid crystal display device 5 is used as an image generating device, but the invention is not limited thereto. For example, an organic electroluminescent device or a plasma display device may be used as the image generating device.

Examples of Electronic Apparatuses Provided with Display Device with Input Function

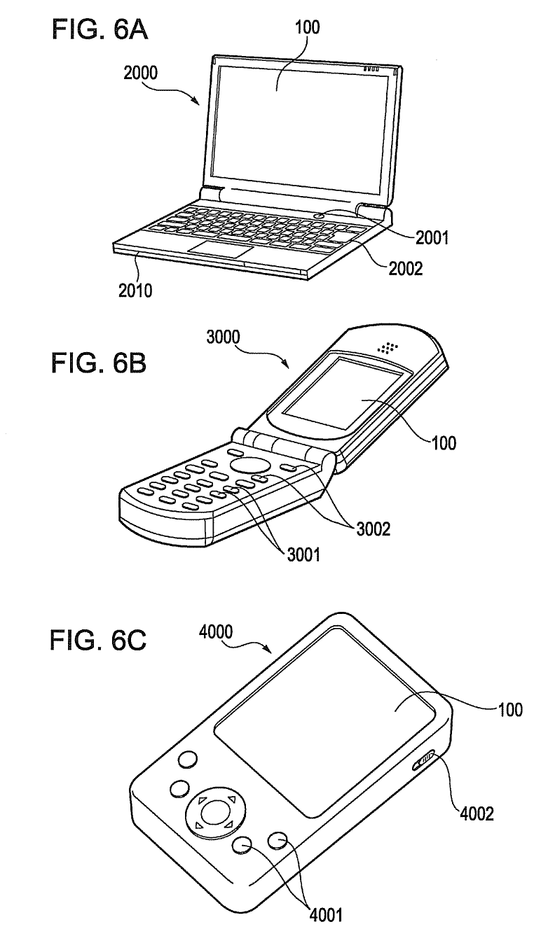

Next, electronic apparatuses provided with the display device 100 with an input function according to the above-described embodiments will be described. FIG. 6A shows the structure of a mobile personal computer provided with the display device 100 with an input function. A personal computer 2000 includes the display device 100 with an input function, serving as a display unit, and a main body 2010. The main body 2010 is provided with a power switch 2001 and a keyboard 2002. FIG. 6B shows the structure of a mobile phone provided with the display device 100 with an input function. A mobile phone 3000 includes a plurality of operating buttons 3001, scroll buttons 3002, and the display device 100 with an input function serving as a display unit. The scroll buttons 3002 are operated to scroll the screen displayed on the display device 100 with an input function. FIG. 6C shows the structure of a personal digital assistant (PDA) provided with the display device 100 with an input function. A personal digital assistant 4000 includes a plurality of operating buttons 4001, a power switch 4002, and the display device 100 with an input function serving as a display unit. When the power switch 4002 is turned on, various information items, such as an address book and a schedule, are displayed on the display device 100 with an input function.

In addition to the electronic apparatuses shown in FIGS. 6A to 6C, the display device 100 with an input function can be applied to various electronic apparatuses, such as a digital still camera, a liquid crystal television, a viewfinder-type or a monitor-direct-view-type video recorder, a navigation apparatus, a pager, an electronic organizer, a calculator, a word processor, a workstation, a video telephone, a POS terminal, and a banking terminal. The display device 100 with an input function can be used as display units of these electronic apparatuses.

What is claimed is:

1. An input device comprising:
a resistive film type input unit; and
a non-contact type input unit that overlaps at least a portion of the resistive film type input unit,
wherein the resistive film type input unit includes:
a first substrate having a first surface and a second surface;
a second substrate having a first surface and a second surface;
a first electrode that is formed on the first surface of the first substrate; and
a second electrode that is formed on the first surface of the second substrate,
the first electrode of the first substrate faces the second electrode of the second substrate,
the resistive film type input unit is in a standby state that does not perform input detection until an input to the non-contact type input unit is detected, and
when the input to the non-contact type input unit is detected, the resistive film type input unit is turned on to perform input detection.

2. An input device comprising:
a resistive film type input unit; and
a capacitance type input unit,
wherein the resistive film type input unit includes:
a first substrate having a first surface and a second surface;
a second substrate having a first surface and a second surface;
a first electrode that is formed on the first surface of the first substrate; and
a second electrode that is formed on the first surface of the second substrate,
the second substrate is provided on an input operation side of the first substrate,
the first electrode of the first substrate faces the second electrode of the second substrate,
the capacitance type input unit includes third electrodes that are provided on the second surface of the second substrate,
the resistive film type input unit is in a standby state that does not perform input detection until an input to the capacitance type input unit is detected, and
when the input to the capacitance type input unit is detected, the resistive film type input unit is turned on to perform input detection.

3. The input device according to claim 1,
wherein the first electrode and the second electrode are maintained at the ground potential in the standby state.

4. The input device according to claim 2,
wherein the first electrode and the second electrode are maintained at the ground potential in the standby state.

5. The input device according to claim 2,
wherein the third electrodes are formed on a base that is composed of a sheet or a substrate different from the second substrate.

6. The input device according to claim 5,
wherein the base is provided such that the third electrodes face the second surface of the second substrate.

7. The input device according to claim 2,
wherein an input region of the capacitance type input unit and an input region of the resistive film type input unit have different sizes in plan view.

8. The input device according to claim 1,
wherein the non-contact type input unit is an optical input unit including light emitting portions and light receiving portions.

9. A display device with an input function comprising:
the input device according to claim 2; and
an image generating device that is provided on one surface of the first substrate of the input device that is opposite to the second substrate.

10. The display device with an input function according to claim 9,
wherein the image generating device includes a pair of substrates and an electro-optical material that is interposed between the pair of substrates, and
the first substrate also serves as one of the pair of substrates.

11. An electronic apparatus comprising the display device with an input function according to claim 9.
